(19) United States
(12) Patent Application Publication
(10) Pub. No.: US 2014/0028779 A1
(43) Pub. Date: Jan. 30, 2014

(54) VIDEO TRANSMITTING APPARATUS AND VIDEO TRANSMITTING METHOD

(71) Applicant: Kabushiki Kaisha Toshiba, Tokyo (JP)

(72) Inventor: Takashi MINEMURA, Tokyo (JP)

(73) Assignee: KABUSHIKI KAISHA TOSHIBA, Tokyo (JP)

(21) Appl. No.: 13/967,024

(22) Filed: Aug. 14, 2013

Related U.S. Application Data
(63) Continuation of application No. PCT/JP2013/058889, filed on Mar. 19, 2013.

(30) Foreign Application Priority Data
Jul. 30, 2012 (JP) 2012-168729

(51) Int. Cl. H04N 7/14

(52) U.S. Cl. CPC H04N 7/147
USPC 348/14.02

(57) ABSTRACT

According to one embodiment, a video transmitting apparatus includes: a first transmitter configured to transmit audio information and video information using a connectionless communication protocol to a communication apparatus connected via a transmission path; a receiver configured to receive a predetermined request; an adjustment module configured to, when the receiver receives the predetermined request, perform adjustment for reducing a frame rate of the video information; and a second transmitter configured to switch from the connectionless communication protocol to a connection communication protocol to transmit the video information adjusted by the adjustment module to the communication apparatus and to maintain transmission of the audio information using the connectionless communication protocol.

### CROSS-REFERENCE TO RELATED APPLICATIONS

This application is a continuation of PCT international application Ser. No. PCT/JP2013/058889, filed Mar. 19, 2013, which designates the United States, incorporated herein by reference, and which is based upon and claims the benefit of priority from Japanese Patent Application No. 2012-168729, filed Jul. 30, 2012, the entire contents of which are incorporated herein by reference.

### FIELD

Embodiments described herein relate generally to a video transmitting apparatus and a video transmitting method.

### BACKGROUND

Conventionally, there have been developed video call systems that connect users via a public network, such as the Internet, and electronic conferencing systems in which a plurality of users can participate.

To transmit a video content together with an audio content via such systems, a user datagram protocol (UDP) is used, which is a connectionless communication protocol having a high transfer rate and low reliability, for example. The UDP has the advantages of facilitating processing and being lowered latency. By using the UDP, video information can be transmitted in nearly real time.

The communication rate of a video content needs to be higher than that of an audio content. Therefore, in the conventional technology, if a connectionless communication protocol, such as the UDP, is used with band limitation on a transmission path, transmission of video has to be abandoned while audio can be transmitted.

### BRIEF DESCRIPTION OF THE DRAWINGS

FIG. 1 is an exemplary schematic diagram of a first example of a network configuration according to a first embodiment;

FIG. 2 is an exemplary schematic diagram of a second example of the network configuration in the embodiment;

FIG. 3 is an exemplary schematic diagram of a third example of the network configuration in the embodiment;

FIG. 4 is an exemplary block diagram of configurations of user terminals in the embodiment;

FIG. 5 is an exemplary flowchart of a process of transmission processing of a video content performed in the user terminal in the embodiment;

FIG. 6 is an exemplary sequence diagram of a process of communication processing performed between a plurality of user terminals in the embodiment;

FIG. 7 is an exemplary sequence diagram of the process of the communication processing performed between the user terminals in the embodiment;

FIG. 8 is an exemplary block diagram of configurations of user terminals according to a second embodiment;

FIG. 9 is an exemplary flowchart of a process of transmission processing of a video content performed in the user terminal in the embodiment;

FIG. 10 is an exemplary sequence diagram of a process of communication processing performed between a plurality of user terminals in the embodiment; and

FIG. 11 is an exemplary sequence diagram of the process of the communication processing performed between the user terminals in the embodiment.

### DETAILED DESCRIPTION

In general, according to one embodiment, a video transmitting apparatus comprises: a first transmitter configured to transmit audio information and video information using a connectionless communication protocol to a communication apparatus connected via a transmission path; a receiver configured to receive a predetermined request; an adjustment module configured to, when the receiver receives the predetermined request, perform adjustment for reducing a frame rate of the video information; and a second transmitter configured to switch from the connectionless communication protocol to a connection communication protocol to transmit the video information adjusted by the adjustment module to the communication apparatus and to maintain transmission of the audio information using the connectionless communication protocol.

### First Embodiment

Exemplary embodiments are described below with reference to the accompanying drawings. In the embodiments described below, a video transmitting apparatus is embodied as an individual user terminal. The user terminal can be applied to various types of apparatuses, such as a mobile personal computer, a mobile phone terminal, a smartphone, and a tablet terminal device.

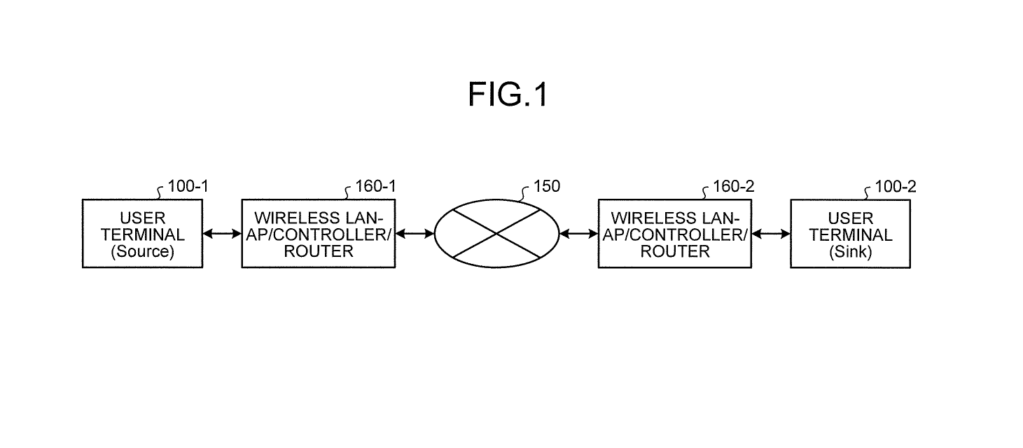

FIG. 1 is a schematic diagram of a first example of a network configuration according to a first embodiment. As illustrated in FIG. 1, user terminals 100-1 and 100-2 are provided. The user terminals 100-1 and 100-2 are connected to a public network 150 via wireless local area network access points (LAN-APs)/controllers/routers 160-1 and 160-2. With this network configuration, data can be transmitted and received between the user terminal 100-1 and the user terminal 100-2.

While transmission and reception of data are performed one to one in the example illustrated in FIG. 1, transmission and reception of data in the first embodiment are not necessarily performed one to one. The transmission and the reception of data may be performed many to many.

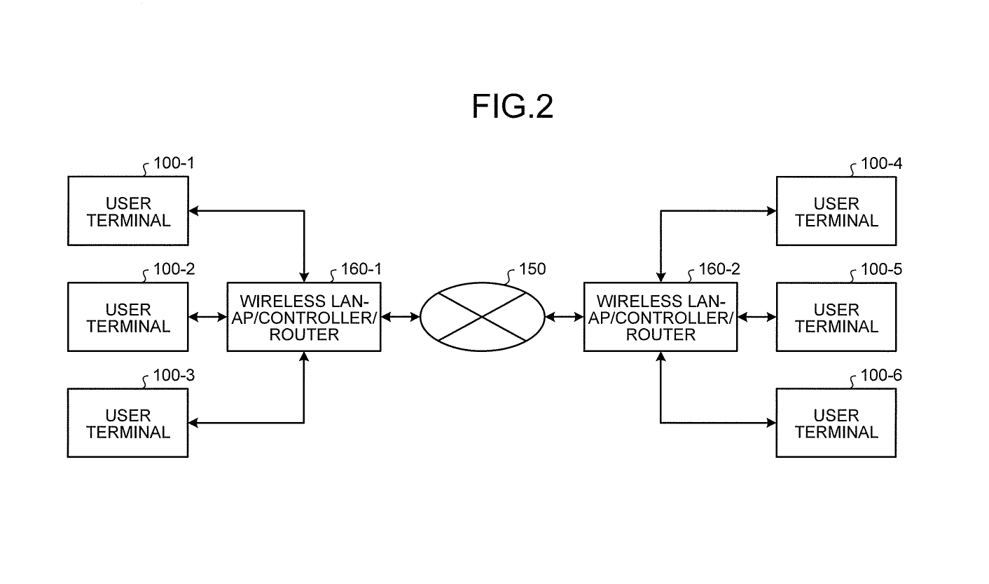

FIG. 2 is a schematic diagram of a second example of the network configuration according to the first embodiment. As illustrated in FIG. 2, user terminals 100-1, 100-2, 100-3, 100-4, 100-5, and 100-6 are provided. The user terminals 100-1 to 100-6 are connected to the public network 150 via the wireless LAN-APs/controllers/routers 160-1 and 160-2.

If the user terminal 100-1 serves as a source device to transmit an audio content and a video content, for example, the other user terminals 100-2 to 100-6 serve as sink devices to display the audio content and the video content thus received. The user terminals 100-2 to 100-6 each have functions as a source device and a sink device. Transmission and reception of an audio content and a video content among the user terminals 100-1 to 100-6 can realize an electronic conferencing system.

While the explanation has been made of the case where each of the user terminals 100-1 to 100-6 transmits an audio content and a video content to each of the other user terminals in FIG. 2, the transmission is not limited to this method. A group owner terminal, for example, may collect video contents and audio contents of user terminals in a small network to transmit and receive the video contents and the audio contents to and from another group owner terminal via a public network.

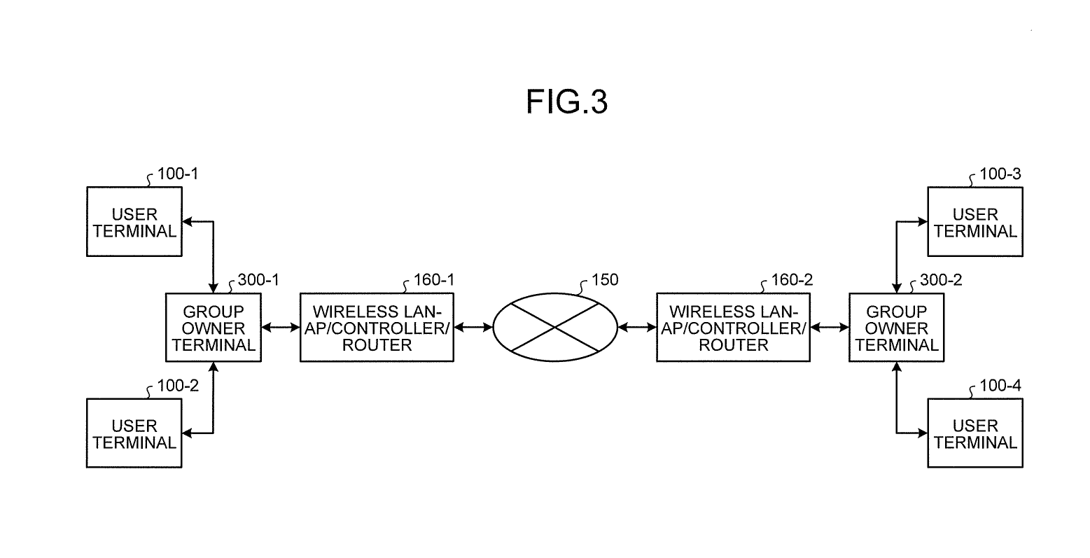

FIG. 3 is a schematic diagram of a third example of the network configuration according to the first embodiment. As illustrated in FIG. 3, the user terminals 100-1, 100-2, 100-3, and 100-4 are provided. A first group owner terminal 300-1 collects video contents and audio contents of the user terminals 100-1 and 100-2 to transmit the video contents and the audio contents to a second group owner terminal 300-2. The second group owner terminal 300-2 then transfers the video contents and the audio contents thus received to the user terminals 100-3 and 100-4. Because the group owner terminals 300-1 and 300-2 collect and control video contents and audio contents of a plurality of user terminals in this manner, it is possible to reduce the load on each user terminal and the load on the network. Furthermore, a video content and an audio content are transmitted and received between the user terminal 100-1 (100-3) and the user terminal 100-2 (100-4). This configuration enables each user terminal to transmit and receive a video content and an audio content to and from the other user terminals, making it possible to realize an electronic conferencing system. With the group owners, the state on the network is the same as the state of one-to-one communications illustrated in FIG. 1, thereby facilitating transmission and reception of data via the network.

To transmit an audio content to the other user terminals, the user terminals 100-1 to 100-6 according to the first embodiment use a connectionless communication protocol. By contrast, to transmit a video content to the other user terminals, the user terminals 100-1 to 100-6 according to the first embodiment switch the communication protocols between a connection communication protocol and a connectionless communication protocol as needed.

A connection communication protocol increases the volume of communications but has a retransmission function. In the first embodiment, a transmission control protocol (TCP) is used as the connection communication protocol.

A connectionless communication protocol has no retransmission function but reduces the volume of communications advantageously. In the first embodiment, a user datagram protocol (UDP) is used as the connectionless communication protocol.

Transfer of a video content requires a larger volume of communications than that of an audio content. Therefore, if the volume of communications is reduced using the UDP with limitation on the network line between user terminals, an audio content can be transmitted, whereas block-noise contamination or the like occurs in a video content. In some cases, the video content is too deteriorated to view, whereby viewing of the video content has to be abandoned.

As described above, the conventional technology uses a connectionless communication protocol to transmit a video content. By contrast, in the first embodiment, if the allowable communication rate of the transmission path is low, a connection communication protocol is used instead of a connectionless communication protocol. In terms of transmission of an audio content, a connectionless communication protocol is used in the same manner as in the conventional technology.

In other words, a connection communication protocol (e.g., the TCP) increases the volume of communications but has a retransmission function compared with a connectionless communication protocol (e.g., the UDP). Therefore, even if the communication capability of a line is low, it is possible to provide a clear video content without block noise by using the retransmission function, instead of an unclear video content including a large amount of block noise.

However, if a connection communication protocol (e.g., the TCP) is used, the volume of communication increases. To address this, control for reducing the frame rate of a video content is also performed so as to transmit the video content even by a line having low communication capability.

As a result, even if the communication capability of a transmission path between a user terminal and a source is low, the user terminal can receive a clear video content having a low frame rate but no block noise instead of an unclear video content including a large amount of block noise.

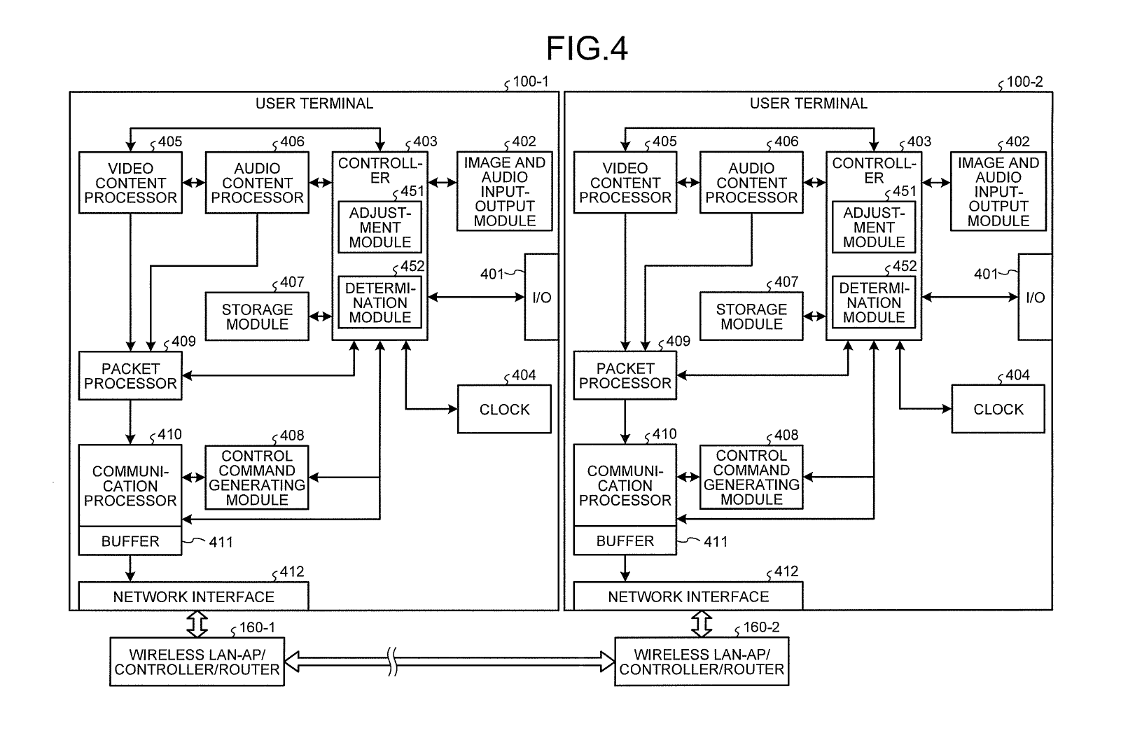

Each configuration of the user terminals 100-1 to 100-6 will now be described. FIG. 4 is a block diagram of the configurations of the user terminals 100-1 and 100-2 according to the first embodiment. In the description below, the user terminal 100-1 is mainly explained. Because the other user terminals 100-2 to 100-6 are considered to have the same configuration and be capable of performing the same processing as those of the user terminal 100-1, explanations thereof will be omitted.

The user terminal 100-1 illustrated in FIG. 4 comprises an I/O 401, an image and audio input-output module 402, a controller 403, a clock 404, a video content processor 405, an audio content processor 406, a storage module 407, a control command generating module 408, a packet processor 409, a communication processor 410, a buffer 411, and a network interface 412.

The image and audio input-output module 402 comprises a display module, a microphone, a speaker, and a camera (none of which is illustrated). The image and audio input-output module 402 receives audio information from the microphone, receives video information from the camera, outputs video information to the display module, and outputs audio information to the speaker.

The controller 403 comprises a control module, such as a central processing unit (CPU), that controls the user terminal 100-1 and a main memory, such as a read-only memory (ROM) and a random access memory (RAM), that stores therein various types of data and various types of computer programs. By executing the various types of computer programs, the controller 403 realizes various types of control.

The clock 404 measures a current date and time to output information indicating the date and time thus measured to the controller 403.

The storage module 407 is realized by a hardware configuration, such as a hard disk drive (HDD), and stores therein various types of data.

The controller 403 according to the first embodiment executes a video transmission program, thereby realizing an adjustment module 451 and a determination module 452.

The determination module 452 determines whether to use a connection communication protocol or a connectionless communication protocol as a communication protocol to be used to transmit a video content. If there is a problem in the quality of a video content being displayed in the user terminals 100-2 to 100-6 serving as destinations of the video contents, for example, the determination module 452 determines to use the connection communication protocol. The presence of a problem in the quality is determined based on whether a request is received from the other user terminals 100-2 to 100-6, for example.

The adjustment module 451 adjusts the frame rate of a video content to be transmitted to the other user terminals 100-2 to 100-6. If retransmission is repeated, for example, the adjustment module 451 performs adjustment so as to reduce the frame rate of the video content. By contrast, if retransmission is not frequently performed, for example, the adjustment module 451 performs adjustment so as to increase the frame rate of the video content.

The video content processor 405 performs various types of processing related to a video content. The video content processor 405 performs encoding of a video content to be transmitted and decoding of a received video content, for example. The audio content processor 406 performs various types of processing related to an audio content.

The control command generating module 408 generates a control command for controlling the other user terminals 100-2 to 100-6. The control command generating module 408 generates a correction request for switching the communication protocols between the connectionless communication protocol and the connection communication protocol, for example. In the first embodiment, the control command generating module 408 generates a GET request for acquiring a video content from the other user terminals 100-2 to 100-6.

The packet processor 409 processes a communication packet. To transmit a video content and an audio content to the other user terminals 100-2 to 100-6, the packet processor 409 divides the video content and the audio content into packet units and attaches a header suitable for each protocol to the packets. In the first embodiment, the packet processor 409 allocates a UDP header to the audio content thus divided to generate a UDP packet. Furthermore, the packet processor 409 allocates a TCP header or a UDP header to the video content thus divided to generate a TCP packet or a UDP packet.

Furthermore, the packet processor 409 combines data contained in a UDP packet and a TCP packet received from the other user terminals 100-2 to 100-6 to generate a video content and an audio content.

The communication processor 410 transmits and receives data to and from the user terminals 100-2 to 100-6 connected via the transmission path (public network 150).

The communication processor 410 according to the first embodiment transmits a video content to the user terminals 100-2 to 100-6 using a connectionless communication protocol (e.g., the UDP) at the start of transmission of the video content. Similarly, the communication processor 410 transmits an audio content using a connectionless communication protocol (e.g., the UDP).

If the volume of communication of the video content is larger than the communication capability of the transmission path (if the video content is not satisfactorily displayed in the destination), the communication processor 410 receives a correction request indicating that display of the video content is not satisfactory from the user terminals 100-2 to 100-6. In the first embodiment, the communication processor 410 receives a GET request from the user terminals 100-2 to 100-6.

When receiving the request, the user terminal 100-1 according to the first embodiment switches transmission to transmission suitable for the user terminals 100-2 to 100-6 that transmit the correction request. Thus, it is possible to transmit the video content without exceeding the capacity of a buffer that temporarily stores therein data before and after the transmission path.

The correction request for switching the methods for transmitting a video content is not limited to a GET request and may be information with which the fact can be found that the video content is not satisfactorily displayed in the user terminals 100-2 to 100-6. The correction request, for example, may be operation data indicating the fact that no video content is displayed and input by a user from the user terminals 100-2 to 100-6 serving as the destinations of the video content. Furthermore, the operation data and the GET request may be combined.

The correction request for switching the communication protocols may be image data displayed in the user terminals 100-2 to 100-6 (indicating a current display state). Furthermore, the correction request may be a text or an e-mail transmitted from the user terminals 100-2 to 100-6. The correction request may be a notification issued to a user who uses the user terminal 100-1 and may be a ringtone or a vibration generated by a vibrator indicating that information is received from the user terminals 100-2 to 100-6, for example. In this case, the user who uses the user terminal 100-1 performs an operation to switch the communication protocols.

The correction request is not limited to a GET request. In a modification, a PUSH request issued from the inside of the apparatus itself may be used. The user terminal 100-1 comprises a rate measuring module (not illustrated) inside thereof, for example. The rate measuring module monitors the transmission rate of the transmission path between the user terminal 100-1 and the destination of the video content, and the control command generating module 408 issues a PUSH request based on the transmission rate, which is the monitoring result. The communication processor 410 then receives the PUSH request and performs the same adjustment as that in the first embodiment. Furthermore, the control command generating module 408 of the user terminal 100-1 may issue a PUSH request based on a reception state of an acknowledgement (ACK) transmitted from the destination in transmission using the connection protocol.

When the correction request is received, the adjustment module 451 of the user terminal 100-1 performs adjustment for reducing the frame rate of the video content. The adjustment for reducing the frame rate may be performed only on the user terminal that transmits the correction request or on all the user terminals.

The communication processor 410 then transmits the video content adjusted by the adjustment module 451 to the user terminals 100-2 to 100-6 by switching the communication protocol from the connectionless communication protocol (e.g., the UDP) to the connection communication protocol (TCP). In addition, the communication processor 410 maintains the transmission of the audio content using the connectionless communication protocol (UDP). In other words, the communication processor 410 may constantly use the connectionless communication protocol to transmit the audio content while switching the communication protocols used to transmit the video content as described above.

By starting the transmission of the video content using the connection communication protocol (TCP), the user terminal 100-1 according to the first embodiment can monitor the number of retransmission requests. The adjustment module 451 then adjusts the frame rate in accordance with the number of retransmission requests.

In the first embodiment, after the communication protocol is switched to the connection communication protocol, the determination module 452 determines whether the number of retransmission (requests) per unit time is equal to or smaller than a predetermined number. If the number of retransmission (requests) is equal to or smaller than the predetermined number, the frame rate is gradually increased. With this configuration, if the determination module 452 determines that the number of retransmission (requests) per unit time is equal to or smaller than the predetermined number despite the fact that the frame rate reaches a predetermined value, it is determined that the transmission path is restored. Asa result, the communication protocol is returned to the connectionless communication protocol (UDP).

To switch the communication protocols between the connection communication protocol and the connectionless communication protocol in the first embodiment, retransmission control in a higher-level layer than a transportation layer may be used. With this configuration, it is possible to switch the communication protocols seamlessly even in the transmission.

As described above, in the first embodiment, the user terminal 100-1 serving as the source device can determine whether to use the connectionless communication protocol or the connection communication protocol.

The buffer 411 temporarily stores therein a packet to be transmitted. Furthermore, the buffer 411 temporarily stores therein a received packet.

The network interface 412 is an interface used to connect the user terminal 100-1 and the wireless LAN-AP/controller/router 160-1. Any wired or wireless method can be employed as the connection method as long as the method enables transmission and reception of data.

In the first embodiment, the video content and the audio content are transmitted indifferent sessions from the start. However, the video content and the audio content may be collectively transmitted at the start, and the video content and the audio content may start to be transmitted in different sessions using reception of the correction request as a trigger.

As described above, in the first embodiment, if the communication capability serving as a bottleneck in the transmission path is not high enough to realize real-time transmission of a video content according to the connectionless communication protocol, the communication protocol is switched to the connection communication protocol in response to a correction request issued from the user terminals 100-2 to 100-6. When the connection communication protocol is used, the frame rate is adjusted depending on the number of retransmission requests, thereby realizing transmission of the video content that satisfies the destination.

Because the user terminal 100-2 that receives a video content from the user terminal 100-1 is also considered to have the same configuration and realize the same processing as those of the user terminal 100-1, an explanation thereof will be omitted.

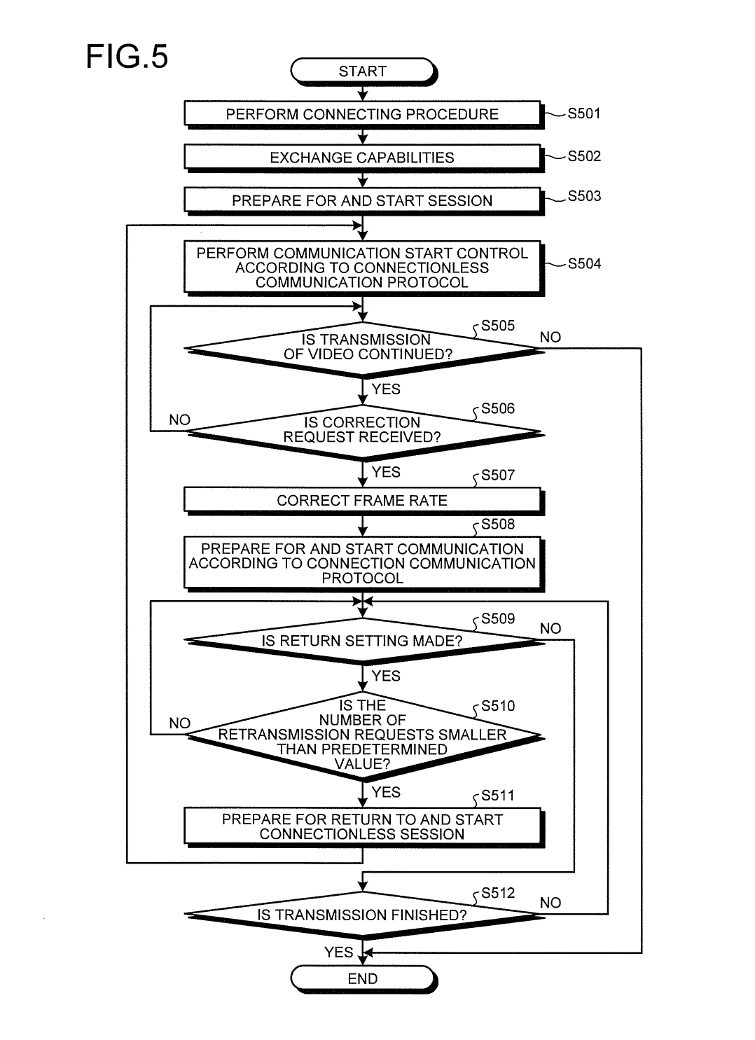

The transmission processing of a video content performed in the user terminal 100-1 according to the first embodiment will now be described. FIG. 5 is a flowchart of a process of the processing described above performed in the user terminal 100-1 according to the first embodiment. Because an audio content is considered to be transmitted using the connectionless communication protocol from the start of transmission to the end thereof, an explanation thereof will be omitted in the processing illustrated in FIG. 5.

The communication processor 410 of the user terminal 100-1 performs a procedure for connecting the user terminal 100-1 and a communication apparatus (e.g., the user terminals 100-2 to 100-6) serving as a destination of a video content (S501).

The communication processor 410 of the user terminal 100-1 performs capability exchange for exchanging capabilities between the user terminals connected to each other (S502).

The communication processor 410 of the user terminal 100-1 prepares for a session according to a connectionless communication protocol (e.g., the UDP) to transmit the video content and starts the session (S503).

The communication processor 410 performs communication start control according to the connectionless communication protocol (e.g., the UDP) between the user terminal 100-1 and the communication apparatus (e.g., the user terminals 100-2 to 100-6) serving as the destination of the video content (S504).

The communication processor 410 determines whether to continue the transmission of the video content to the other communication apparatus (e.g., the user terminals 100-2 to 100-6) (S505). If the communication processor 410 determines not to continue the transmission (No at S505), the processing is terminated.

By contrast, if the communication processor 410 determines to continue the transmission of the video content (Yes at S505), the determination module 452 determines whether a correction request indicating that the video content is not satisfactory is accepted (received) from the other communication apparatus (e.g., the user terminals 100-2 to 100-6) (S506). If no correction request is accepted (No at S506), the system control is returned to S505.

If the determination module 452 determines that a correction request is accepted (Yes at S506), the adjustment module 451 performs correction for reducing the frame rate of the video content to be transmitted (S507). While the range of reduction in the frame rate may be a value determined in accordance with an aspect of the embodiment, the range of reduction in the frame rate is preferably set to a value larger than communication capability including retransmission to be increased in association with switching of the communication protocols from the connectionless communication protocol to a connection communication protocol. As a result, switching the communication protocols makes it possible to reduce the total volume of communications.

The communication processor 410 prepares for communications according to the connection communication protocol and performs communication start control (S508). At this time, a packet generated by the packet processor 409 is also switched from a UDP packet to a TCP packet.

Subsequently, the determination module 452 determines whether return setting for returning from the connection communication protocol to the connectionless communication protocol is made (S509). If no return setting is made (No at S509), the communication processor 410 determines whether to finish the transmission of the video content to the other communication apparatus (e.g., the user terminals 100-2 to 100-6) (S512). If the communication processor 410 determines not to finish the transmission (No at S512), the communication processor 410 continues the transmission of the video content, and the system control is returned to S509. By contrast, if the communication processor 410 determines to finish the transmission (Yes at S512), the communication processor 410 finishes the transmission of the video content.

If return setting is made at S509 (Yes at S509), the determination module 452 determines whether the number of requests for retransmission of the video content issued from the other communication apparatus (e.g., the user terminals 100-2 to 100-6) per predetermined unit time is smaller than a predetermined value (S510). If the determination module 452 determines that the number of requests for retransmission is equal to or larger than the predetermined value (No at S510), the communication processor 410 continues the transmission of the video content, and the system control is returned to S509.

By contrast, if the determination module 452 determines that the number of requests for retransmission of the video content is smaller than the predetermined value (Yes at S510), the communication capability of the transmission path is considered to be restored, whereby the communication processor 410 prepares for a return to the UDP session according to the connectionless communication protocol and restarts communication control in the UDP session (S511). At this time, the adjustment module 451 may adjust the frame rate of the video content to be transmitted. Subsequently, the system control is returned to S504.

With the series of processes described above, if a video content is not satisfactorily displayed, using the retransmission function and the like of the connection communication protocol reduces the frame rate, but makes it possible to display the video content in the destination. Furthermore, when the communication capability of the transmission path is restored to predetermined capability, by increasing the frame rate or switching the communication protocol to the connectionless communication protocol depending on the state of the transmission path, it is possible to transmit the video content within the optimum range allowed by the transmission path used by the user terminal 100-1. The predetermined capability is determined in accordance with an aspect of the embodiment.

In the flowchart illustrated in FIG. 5, the explanation has been made of the case where the user terminal 100-1 receives the correction request and automatically switches the communication protocols. However, the correction request may be transmitted to the user of the user terminal 100-1, and the user who receives the correction request may manually switch the communication protocol from the connectionless communication protocol to the connection communication protocol. Furthermore, the controller 403 of the user terminal 100-1 may generate a graphical user interface (GUI) indicating the communication protocol used to transmit the video and a GUI indicating the frame rate of the video content to be transmitted and display the GUI on the display module.

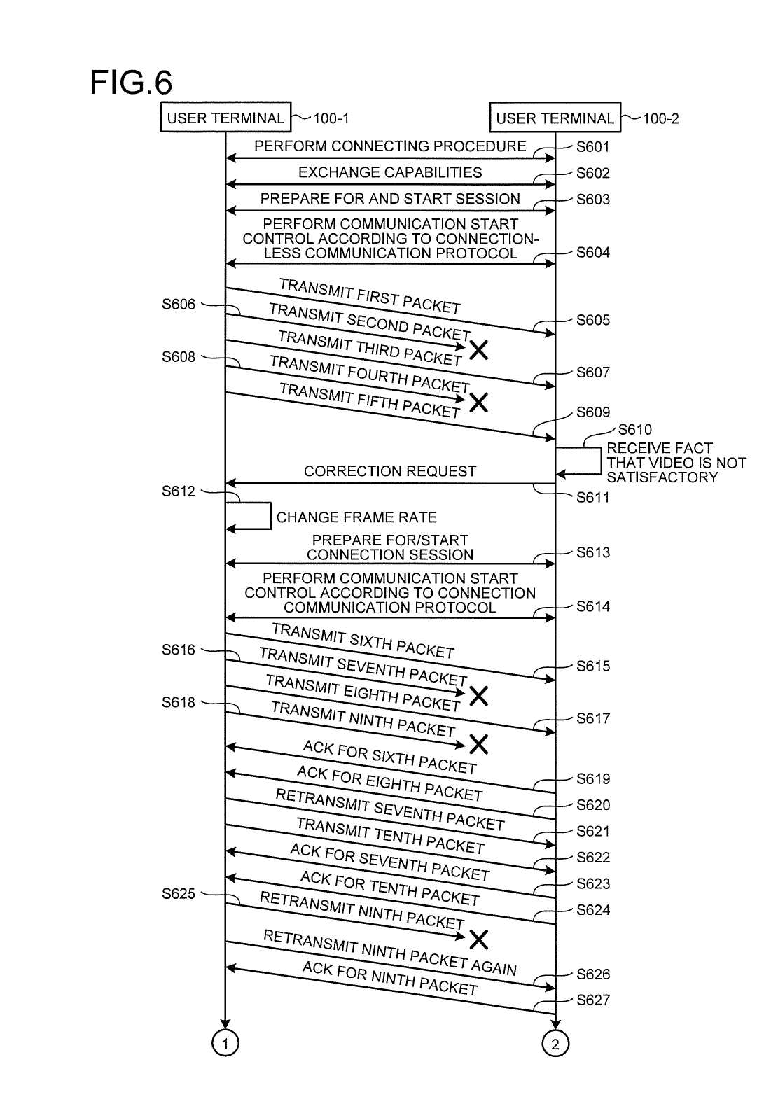

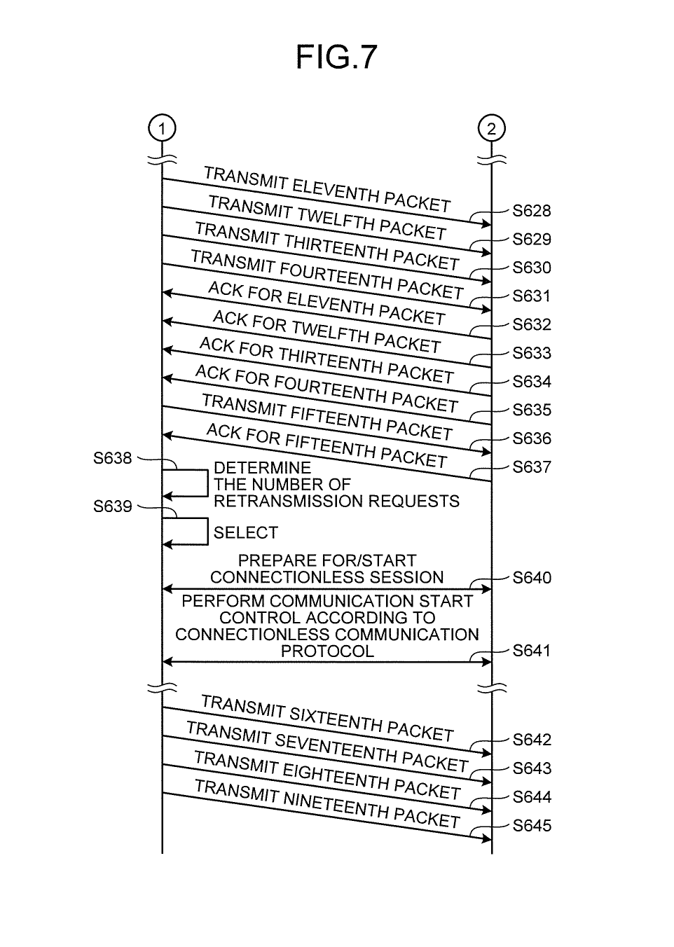

The communication processing between the user terminal 100-1 and the user terminal 100-2 according to the first embodiment will now be described. FIG. 6 and FIG. 7 are sequence diagrams of a process of the processing described above between the user terminal 100-1 and the user terminal 100-2 according to the first embodiment. Because an audio content is considered to be transmitted under communication control using the connectionless communication protocol, an explanation thereof will be omitted in the sequence diagram illustrated in FIG. 6 and FIG. 7.

The communication processor 410 of the user terminal 100-1 performs a procedure for connecting the user terminal 100-1 and the user terminal 100-2 serving as a destination of a video content (S601).

The communication processor 410 of the user terminal 100-1 performs capability exchange for exchanging capabilities between the user terminal 100-1 and the user terminal 100-2 connected thereto (S602).

The capability exchange is not necessarily performed at this timing in the flow. In this case, the processing at S602 may be performed.

The communication processor 410 of the user terminal 100-1 prepares for a session according to the connectionless communication protocol (e.g., the UDP) to transmit the video content between the user terminal 100-1 and the user terminal 100-2 connected thereto and starts the UDP session (S603).

The communication processor 410 then performs communication start control according to the connectionless communication protocol (e.g., the UDP) between the user terminal 100-1 and the user terminal 100-2 (S604).

The user terminal 100-1 transmits first to fifth packets storing therein the video content to the user terminal 100-2 (S605 to S609). An assumption is made that errors occur in transmission of the second packet and the fourth packet (S606 and S608) among the packets thus transmitted.

With these errors, the video content is not satisfactorily displayed. As a result, the user terminal 100-2 receives an input indicating that the video is not satisfactory from the user (S610). The explanation has been made of the case where the input indicating that the video is not satisfactory is received from the user. However, the determination module 452 of the user terminal 100-2 may use the packets thus received to determine whether the video is satisfactory based on the reception state of the communication packets.

As a result, the communication processor 410 of the user terminal 100-2 transmits a correction request to the user terminal 100-1 (S611).

The adjustment module 451 of the user terminal 100-1 that receives the correction request performs correction for reducing the frame rate of the video content to be transmitted (S612).

Furthermore, the communication processor 410 of the user terminal 100-1 prepares for a TCP (connection) session according to the connection communication protocol between the user terminal 100-1 and the user terminal 100-2 and starts the TCP session (S613).

The communication processor 410 then performs communication start control according to the connection communication protocol (e.g., the TCP) between the user terminal 100-1 and the user terminal 100-2 (S614).

The user terminal 100-1 transmits sixth to ninth packets storing therein the video content to the user terminal 100-2 (S615 to S618). An assumption is made that errors occur in transmission of the seventh packet and the ninth packet (S616 and 5618) among the packets thus transmitted.

The communication processor 410 of the user terminal 100-2 returns ACKs corresponding to the sixth packet and the eighth packet to the user terminal 100-1 (S619 and S620).

With the ACKs at S619 and S620, it is found that an error occurs in transmission of the seventh packet. As a result, the communication processor 410 of the user terminal 100-1 retransmits the seventh packet to the user terminal 100-2 (S621). Furthermore, the communication processor 410 of the user terminal 100-1 transmits the tenth packet to the user terminal 100-2 (S622).

The communication processor 410 of the user terminal 100-2 returns ACKs corresponding to the seventh packet and the tenth packet to the user terminal 100-1 (S623 and S624).

With the ACKs at S620 and S624, it is found that an error occurs in transmission of the ninth packet. As a result, the communication processor 410 of the user terminal 100-1 retransmits the ninth packet to the user terminal 100-2 (S625). An assumption is made that an error occurs also in the retransmission.

If no ACK of the ninth packet is returned in a predetermined time period, the communication processor 410 of the user terminal 100-1 retransmits the ninth packet again (S626). The communication processor 410 of the user terminal 100-2 returns an ACK corresponding to the ninth packet to the user terminal 100-1 (S627). Thus, transmission of the first to the tenth packets is completed.

Subsequently, the communication processor 410 of the user terminal 100-1 transmits eleventh to fourteenth packets to the user terminal 100-2 (S628 to S631). The communication processor 410 of the user terminal 100-2 returns ACKs corresponding to the eleventh to the fourteenth packets to the user terminal 100-1 (S632 to S635).

Furthermore, the communication processor 410 of the user terminal 100-1 transmits a fifteenth packet to the user terminal 100-2 (S636). The communication processor 410 of the user terminal 100-2 returns an ACK corresponding to the fifteenth packet to the user terminal 100-1 (S637).

Subsequently, the determination module 452 of the user terminal 100-1 determines whether the number of retransmission requests is equal to or smaller than a predetermined value (S638). An assumption is made that the number of retransmission requests is determined to be equal to or smaller than the predetermined value in the sequence diagram illustrated in FIG. 7.

As a result, the determination module 452 selects the connectionless communication protocol as the protocol to be used (S639).

The communication processor 410 of the user terminal 100-1 prepares for a return to the UDP session according to the connectionless communication protocol and restarts communication control in the UDP session (S640).

The communication processor 410 then performs communication start control according to the connectionless communication protocol (S641).

As a result, the communication processor 410 of the user terminal 100-1 transmits sixteenth to nineteenth packets to the user terminal 100-2 using the UDP (S642 to S645).

As described above, after the communication protocol is switched to the TCP, it is possible to transmit the video content without any lack by using the retransmission function. In an electronic conferencing system, the priority of the real-time property of a video content is lower than that of an audio content. Therefore, even if using the retransmission function reduces the real-time property of the video content, it is possible to display the video content reliably, thereby improving the convenience.

In the first embodiment, the communication protocols may be switched without terminating the session. In this case, when switching the communication protocols between the connection communication protocol and the connectionless communication protocol, the communication processor 410 determines whether retransmission of the video content is required using a communication protocol in a higher-level layer than those of the connection communication protocol and the connectionless communication protocol. If it is determined that the retransmission is required, the communication processor 410 retransmits the video content. Examples of the protocol in a higher-level layer include a session initiation protocol (SIP) and a real-time transport control protocol (RTCP).

In the first embodiment, the source device that transmits a video content and the sink device that receives the video content are explained separately to facilitate the explanation. However, in an actual conferencing system and the like, the user terminals 100-1 to 100-6 may function as both the source devices and the sink devices. As described above, the user terminals 100-1 to 100-6 may perform interactive communications of a video content and an audio content simultaneously.

While the explanation has been made of the various aspects of the correction request in the first embodiment, the correction request is not limited to the command for switching the communication protocols. The correction request may be a request that causes the user of the user terminal 100-1 to notice the fact that display of the video content does not satisfy the requirements and to deal with the unsatisfactory display. The correction request may be a text in a chat, an e-mail, an image displayed by the user terminal serving as the destination, or a thumbnail of the image, for example. The same applies to modifications and the like, which will be described later.

No method for synchronizing the video content and the audio content is described in the first embodiment. However, by using transmission information serving as a time stamp or using a timer in the apparatus, for example, it is possible to synchronize the video content and the audio content at a certain level of accuracy.

By using the request that causes the user to notice the unsatisfactory display, the user terminal 100-1 serving as the source device can grasp how the video content is being displayed in the user terminal serving as the sink device. As a result, display of the video content can be improved by operations performed by the user. Furthermore, because how the video content is being displayed in the destination can be grasped, it is possible to reduce a sense of unease of the user due to remote communications.

In the first embodiment, when switching the communication protocols, the adjustment module 451 performs control for reducing the frame rate to reduce the volume of communications of the video content. However, the method for reducing the volume of communications is not limited to reduction in the frame rate. The volume of data may be reduced by reducing resolution or color depth, for example.

### First Modification of First Embodiment

While the explanation has been made of the case where the video content is transmitted in response to the GET request issued from the user terminal serving as the destination in the first embodiment, it is not limited to the GET request. The video content may be transmitted in response to a PUSH request issued from the user terminal serving as the source. Thus, even if no request recognizable by the user terminal serving as the source device can be issued because of difference of manufacturers, for example, the source device can transmit the video content.

### Second Modification of First Embodiment

While the explanation has been made of the case where the correction request is a command for switching the communication protocols or information that causes the user to notice the unsatisfactory display, the correction request is not limited thereto and may be a state of the transmission path.

The user terminal 100-1 may receive a data transmission rate of the transmission path measured by the user terminal serving as the destination of the video content as the correction request, for example. If the data transmission rate is smaller than a predetermined value, the user terminal 100-1 may switch the communication protocols.

Furthermore, the user terminal 100-1 may comprise a rate measuring module inside thereof and output a data transmission rate of the transmission path measured by the rate measuring module to the determination module 452 as the correction request. The determination module 452 may determine whether to switch the communication protocols based on the data transmission rate included in the correction request. By measuring the data transmission rate of the transmission path in the source device in this manner, it is possible to determine whether the video content can be transmitted without waiting for a notification issued from other devices.

### Third Modification of First Embodiment

The correction request may be a still image or a video content being displayed in the user terminal serving as the destination of the video content. To check the quality of the transmission path, the user terminal 100-1 serving as the source may increase the number of pieces of the video content to be transmitted per unit time by a method such as replication and interpolation or increase the data size of one image (that is, increase the volume of communications). Subsequently, the user terminal 100-1 may transmit the video content to the user terminal serving as the sink device via the transmission path.

The user terminal serving as the sink device then transmits a display result of the video content to the source device as a still image or a video content. The display result is used as the correction request. Thus, the user terminal 100-1 serving as the source device can determine the state of the transmission path, whether to retransmit the video content, or whether the video content thus transmitted satisfies predetermined quality.

As described above, the size of the video content is purposely increased before the transmission as the method for checking the communication rate of the transmission path in the third modification. By checking how the video content is being displayed in the destination, it is possible to grasp the quality of the transmission path. Performing the processing periodically makes it possible to grasp the state of the transmission path that changes over time. By grasping the state of the transmission path, it is possible to adjust the frame rate depending on the state of the transmission path when transmitting the video content. This makes it possible to transmit a video content that highly satisfies the user terminal serving as the destination.

### Fourth Modification of First Embodiment

In terms of the user terminal according to a fourth modification of the first embodiment, the user terminal 100-1 serving as the source device comprises a monitoring module that monitors the capacity of the buffer 411, and a monitoring result obtained by the monitoring module (a stored state of packets of the video content in the buffer 411) is received as a request for switching the communication protocols. The user terminal then switches the communication protocols for the video content to be transmitted by the communication processor 410 based on the request thus received, that is, on the capacity of the buffer 411.

Specifically, the determination module 452 determines whether the capacity of the buffer 411 accounts for equal to or more than a predetermined capacity based on the monitoring result. If the capacity accounts for equal to or more than the predetermined capacity, it is determined that the video content is not appropriately transmitted and that the video content is not satisfactorily displayed in the destination. Therefore, the communication protocol is switched from the connectionless communication protocol to the connection communication protocol. Thus, it is possible to switch the communication protocols correspondingly to the sink device without receiving a request from the user terminals 100-2 to 100-6 serving as the sink devices.

### Second Embodiment

In the first embodiment, the explanation has been made of the case where communications for the video content are started using the connectionless communication protocol and the communication protocol is switched to the connection communication protocol as needed. However, it is not limited to the method for performing communications using the connectionless communication protocol at the start, and the communication protocols may be switched as needed. In a second embodiment, an explanation will be made of the case where, in transmission of a video content, the connection communication protocol is used and the transmission is started with the frame rate reduced.

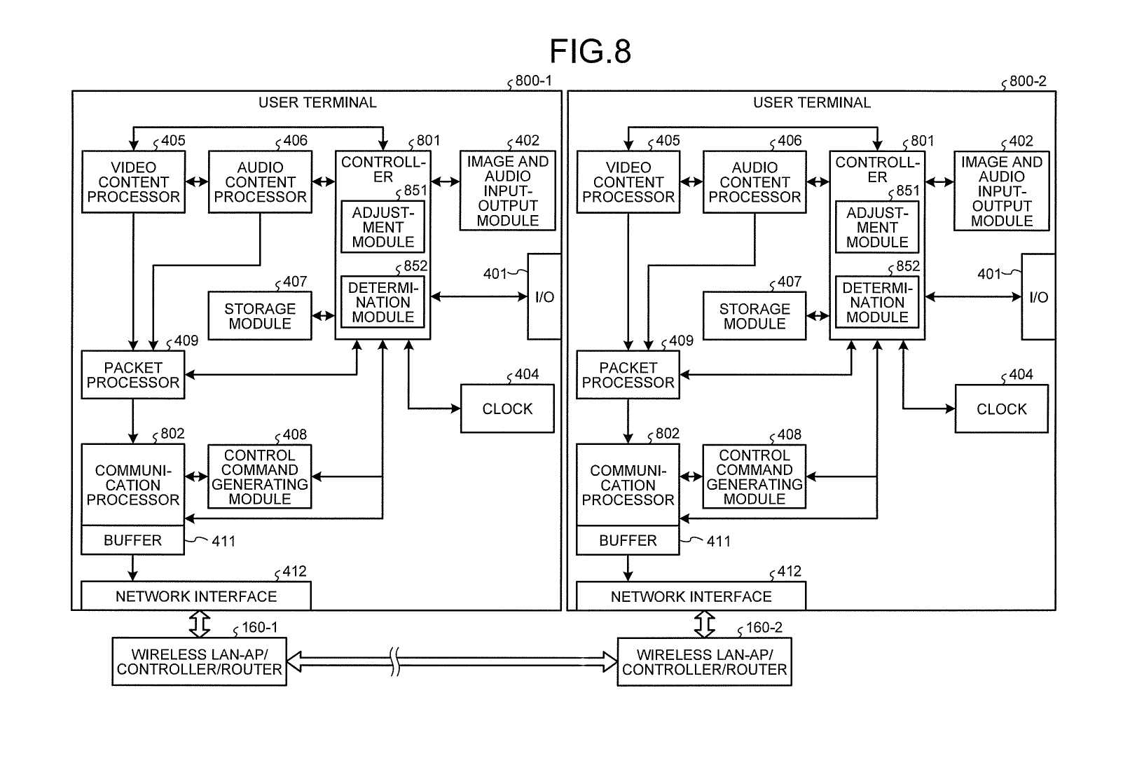

FIG. 8 is a block diagram of the configurations of user terminals 800-1 and 800-2 according to the second embodiment. The user terminals 800-1 and 800-2 according to the second embodiment illustrated in FIG. 8 are each provided with a communication processor 802 and a controller 801 that perform different processing from that of the communication processor 410 and the controller 403, respectively, in the user terminals 100-1 and 100-2 according to the first embodiment described above.

When starting transmission of a video content, the communication processor 802 of the user terminal 800-1 starts the transmission using the connection communication protocol (e.g., the TCP). An audio content is transmitted using the connectionless communication protocol (e.g., the UDP).

The controller 801 comprises an adjustment module 851 and a determination module 852.

After the communication processor 802 starts the communications using the connection communication protocol, the determination module 852 of the user terminal 800-1 according to the second embodiment determines whether retransmission of the video content is performed frequently.

In the second embodiment, the determination module 852 determines whether the number of requests for retransmission of the video content according to the connection communication protocol is equal to or smaller than a predetermined number. If the number of retransmission requests is determined to be larger than the predetermined number, that is, if retransmission is determined to be performed frequently, it is considered that the state of the transmission path is not good. In this case, the adjustment module 851 maintains the frame rate of the video content or performs adjustment for further reducing the frame rate.

By contrast, if the determination module 852 determines that the number of retransmission requests is equal to or smaller than the predetermined number and the frame rate of the video content is smaller than a frame rate specified as the maximum value, the adjustment module 851 performs adjustment for increasing the frame rate.

Subsequently, the determination module 852 further determines whether the number of retransmission requests is equal to or smaller than a predetermined number. If the number of retransmission requests is equal to or smaller than the predetermined number even in the maximum frame rate, it is determined that a sufficient rate is ensured for the transmission path. As a result, the user terminal 800-1 switches the communication protocol to be used to transmit the video content from the connection communication protocol to the connectionless communication protocol. The predetermined number serving as a criterion for increasing the frame rate and the predetermined number serving as a criterion for switching the communication protocols may be the same number or different numbers.

Thereafter, the communication processor 802 of the user terminal 800-1 uses the connectionless communication protocol to transmit the video content to the user terminal 800-2 and maintains transmission according to the connectionless communication protocol for an audio content. In other words, the communication processor 802 may constantly use the connectionless communication protocol to transmit the audio content while switching the communication protocols used to transmit the video content as described above.

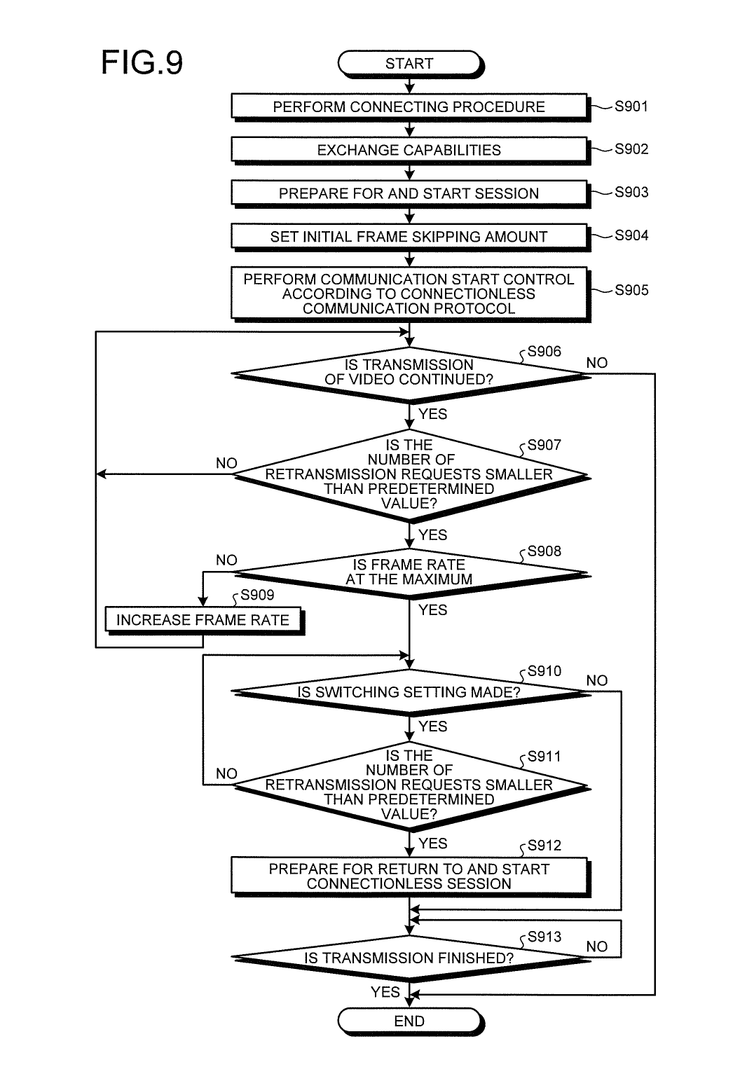

The transmission processing of a video content performed in the user terminal 800-1 according to the second embodiment will now be described. FIG. 9 is a flowchart of a process of the processing described above performed in the user terminal 800-1 according to the second embodiment. Because an audio content is considered to be transmitted using the connectionless communication protocol from the start of transmission to the end thereof, an explanation thereof will be omitted in the processing illustrated in FIG. 9.

The communication processor 802 of the user terminal 800-1 performs a procedure for connecting the user terminal 800-1 and a communication apparatus (e.g., the user terminal 800-2) serving as a destination of a video content (S901).

The communication processor 802 of the user terminal 800-1 performs capability exchange for exchanging capabilities between the user terminals connected to each other (S902).

The communication processor 802 of the user terminal 800-1 prepares for a TCP session to transmit the video content and starts the TCP session (S903).

The adjustment module 851 sets an initial frame skipping amount for the video content to be transmitted (S904).

The communication processor 802 performs communication start control according to the connection communication protocol (e.g., the TCP) between the user terminal 800-1 and the communication apparatus (e.g., the user terminal 800-2) serving as the destination of the video content (S905).

The communication processor 802 determines whether to continue the transmission of the video content to the other communication apparatus (e.g., the user terminal 800-2) (S906). If the communication processor 802 determines not to continue the transmission (No at S906), the processing is terminated.

By contrast, if the communication processor 802 determines to continue the transmission of the video content (Yes at S906), the determination module 852 determines whether the number of requests for retransmission of the video content issued from the other communication apparatus (e.g., the user terminal 800-2) is smaller than a predetermined value (S907). If the determination module 852 determines that the number of requests for retransmission of the video content is equal to or larger than the predetermined value (No at S907), the system control is returned to S906. When the system control is returned to S906, the adjustment module 851 may perform adjustment for further reducing the frame rate of the video content.

If the determination module 852 determines that the number of requests for retransmission of the video content is smaller than the predetermined value (Yes at S907), the determination module 852 determines whether the frame rate of the video content to be transmitted is at the maximum value (S908). The maximum value of the frame rate is the maximum value predetermined as a frame rate in which transmission can be performed.

If the determination module 852 determines that the frame rate is not at the maximum value (No at S908), the adjustment module 851 increases the frame rate of the video content by a predetermined amount (S909). Subsequently, the system control is returned to S906.

By contrast, if the determination module 852 determines that the frame rate is at the maximum value (Yes at S908), the determination module 852 determines whether switching setting for switching the communication protocols is made (S910). If the determination module 852 determines that no switching setting is made (No at S910), the communication processor 802 determines whether to finish the transmission of the video content to the other communication apparatus (e.g., the user terminal 800-2) (S913). If the communication processor 802 determines not to finish the transmission (No at S913), the communication processor 802 continues the transmission of the video content and reperforms the processing at S913. If the communication processor 802 determines to finish the transmission (Yes at S913), the communication processor 802 stops the transmission of the video content, and the processing is terminated.

If switching setting is made at S910 (Yes at S910), the determination module 852 determines whether the number of requests for retransmission of the video content issued from the other communication apparatus (e.g., the user terminal 800-2) per predetermined unit time is smaller than a predetermined value (S911). If the determination module 852 determines that the number of requests for retransmission is equal to or larger than the predetermined value (No at S911), the communication processor 802 continues the transmission of the video content, and the system control is returned to S910.

By contrast, if the determination module 852 determines that the number of requests for retransmission of the video content is smaller than the predetermined value (Yes at S911), the communication processor 802 prepares for a return to the UDP session according to the connectionless communication protocol and restarts communication control in the UDP session (S912).

Subsequently, the communication processor 802 determines whether to finish the transmission of the video content to the other communication apparatus (e.g., the user terminal 800-2) (S913). If the communication processor 802 determines not to finish the transmission (No at S913), the communication processor 802 continues the transmission of the video content and reperforms the processing at S913. If the communication processor 802 determines to finish the transmission (Yes at S913), the communication processor 802 stops the transmission of the video content, and the processing is terminated.

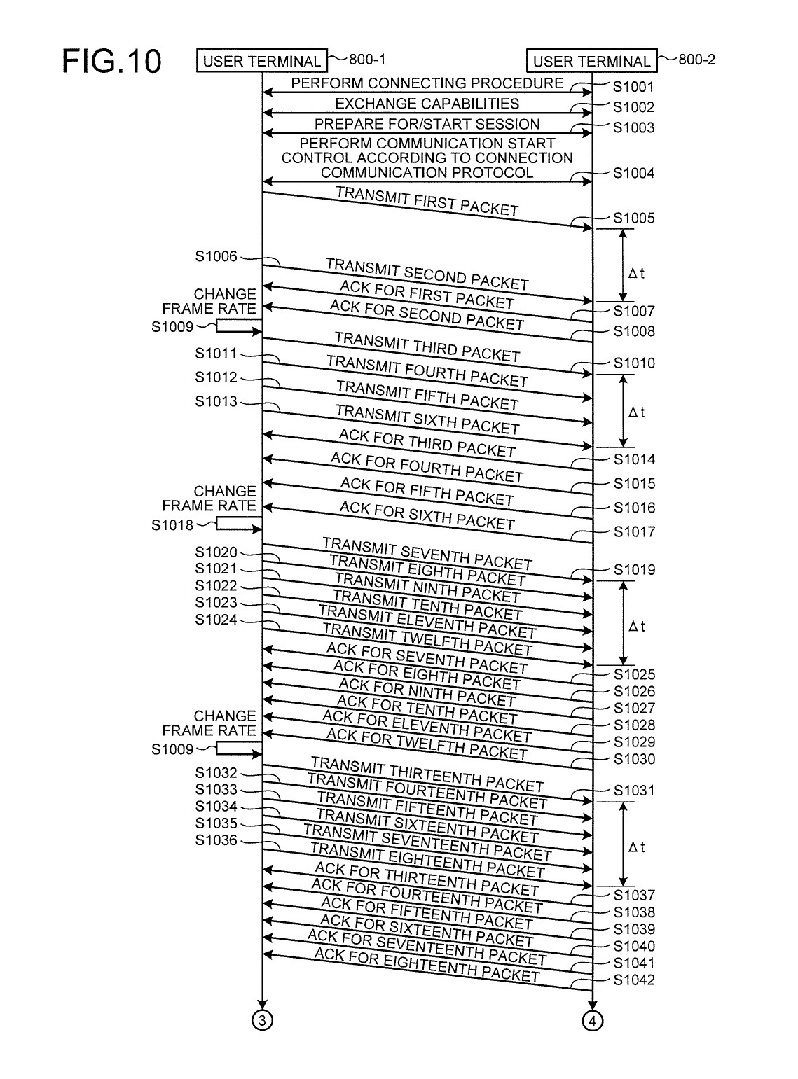

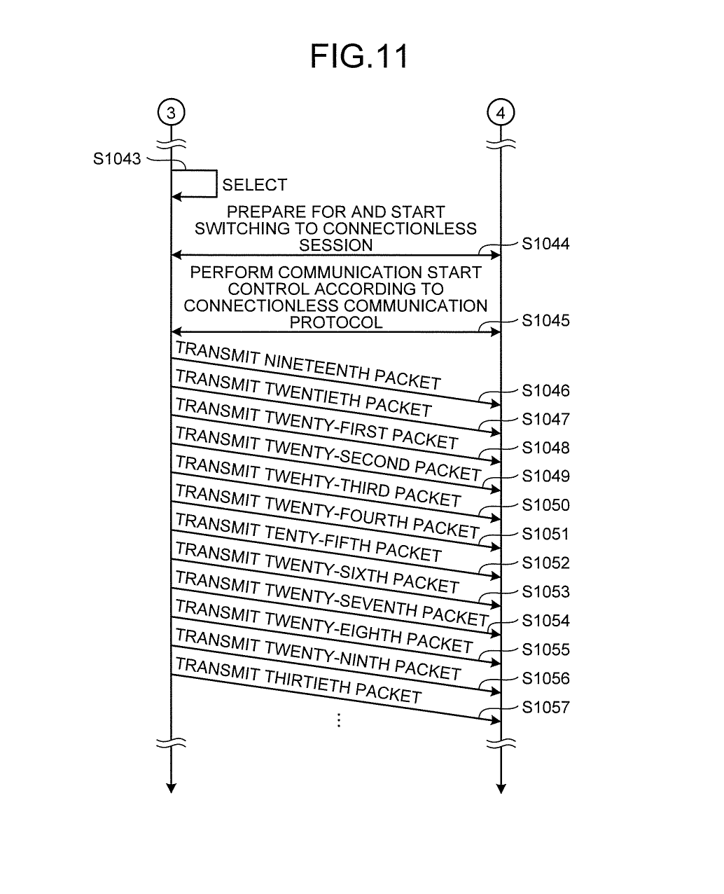

The communication processing between the user terminal 800-1 and the user terminal 800-2 according to the second embodiment will now be described. FIG. 10 and FIG. 11 are sequence diagrams of a process of the processing described above between the user terminal 800-1 and the user terminal 800-2 according to the second embodiment. Because an audio content is considered to be transmitted under communication control using the connectionless communication protocol, an explanation thereof will be omitted in the sequence diagram illustrated in FIG. 10 and FIG. 11.

The communication processor 802 of the user terminal 800-1 performs a procedure for connecting the user terminal 800-1 and the user terminal 800-2 serving as a destination of a video content (S1001).

The communication processor 802 of the user terminal 800-1 performs capability exchange for exchanging capabilities between the user terminal 800-1 and the user terminal 800-2 connected thereto (S1002).

The communication processor 802 of the user terminal 800-1 prepares for a TCP session to transmit the video content between the user terminal 800-1 and the user terminal 800-2 connected thereto and starts the TCP session (S1003).

The communication processor 802 then performs communication start control according to the connection communication protocol (e.g., the TCP) between the user terminal 800-1 and the user terminal 800-2 (S1004).

The user terminal 800-1 transmits first and second packets storing therein the video content to the user terminal 800-2 (S1005 and S1006). At S1005 and S1006, the user terminal 800-1 transmits two packets in a predetermined time period ΔT.

The communication processor 802 of the user terminal 800-2 returns ACKs corresponding to the first packet and the second packet to the user terminal 800-1 (S1007 and S1008).

The determination module 852 determines whether the number of retransmission requests is equal to or smaller than a predetermined value based on the return result. The adjustment module 851 then performs control for increasing the frame rate of the video content (S1009). An increase in the frame rate increases the number of packets to be transmitted.

As a result, the user terminal 800-1 transmits third to sixth packets storing therein the video content to the user terminal 800-2 (S1010 to S1013). At S1010 to S1013, the user terminal 800-1 transmits four packets in the predetermined time period ΔT.

The communication processor 802 of the user terminal 800-2 returns ACKs corresponding to the third to the sixth packets to the user terminal 800-1 (S1014 to S1017).

The determination module 852 determines whether the number of retransmission requests is equal to or smaller than the predetermined value based on the return result. The adjustment module 851 then performs control for increasing the frame rate of the video content (S1018). An increase in the frame rate increases the number of packets to be transmitted.

As a result, the user terminal 800-1 transmits seventh to twelfth packets storing therein the video content to the user terminal 800-2 (S1019 to S1024). At S1019 to S1024, the user terminal 800-1 transmits six packets in the predetermined time period ΔT.

The communication processor 802 of the user terminal 800-2 returns ACKs corresponding to the seventh to the twelfth packets to the user terminal 800-1 (S1025 to S1030).

The determination module 852 determines whether the number of retransmission requests is equal to or smaller than the predetermined value based on the return result. Because the frame rate is at the maximum value, the transmission of packets is continued without changing the frame rate.

The user terminal 800-1 transmits thirteenth to eighteenth packets storing therein the video content to the user terminal 800-2 (S1031 to S1036).

The communication processor 802 of the user terminal 800-2 returns ACKs corresponding to the thirteenth to the eighteenth packets to the user terminal 800-1 (S1037 to S1042).

Subsequently, because the number of retransmission requests is equal to or smaller than the predetermined value, the determination module 852 switches the protocol to be used from the connection communication protocol to the connectionless communication protocol (S1043).

The communication processor 802 of the user terminal 800-1 prepares for a UDP session to transmit the video content between the user terminal 800-1 and the user terminal 800-2 connected thereto and starts the UDP session (S1044).

The communication processor 802 performs communication start control according to the connectionless communication protocol (e.g., the UDP) between the user terminal 800-1 and the user terminal 800-2 (S1045).

The communication processor 802 of the user terminal 800-1 transmits nineteenth to thirtieth packets to the user terminal 800-2 using the connectionless communication protocol (e.g., the UDP) (S1046 to S1057).

Also in the second embodiment, the communication protocols may be switched between the connection communication protocol and the connectionless communication protocol without terminating the session in the same manner as in the first embodiment. In this case, whether retransmission is required is determined using a communication protocol in a higher-level layer than those of the connection communication protocol and the connectionless communication protocol. If it is determined that the retransmission is required, the video content is retransmitted. Examples of the protocol in a higher-level layer include the SIP and the RTCP.

In the second embodiment, in transmission of a video content, the connection communication protocol is used at the start of the transmission and the degree of frame skipping is adjusted depending on the number of retransmission requests. If no problem occurs even in the maximum frame rate, the communication protocol is switched to the connectionless communication protocol. As a result, it is possible to provide the video content that satisfies the destination. In addition, by switching the communication protocol to the connectionless communication protocol, the processing load can be reduced.

### First Modification of Second Embodiment

While the explanation has been made of the case where the frame rate is increased and the communication protocol is switched to the connectionless communication protocol depending on the number of retransmission requests, the switching is not necessarily performed depending on the number of retransmission requests. The frame rate may be increased and the communication protocols may be switched in response to a request in the same manner as in the first embodiment.

In a first modification of the second embodiment, the user terminal transmits a video content using the connection communication protocol (e.g., the TCP) at the start. If a request indicating the fact that the video content is being displayed with no problem (or the fact that the quality of the video content is desired to be enhanced) from the user terminal serving as the destination, the frame rate is increased and the communication protocol is switched to the connectionless communication protocol, for example. Examples of the types of request include various aspects similarly to the first embodiment. Because the process for switching the communication protocols and other processes are the same as those in the second embodiment, explanations thereof are omitted.

### Second Modification of Second Embodiment

While the explanation has been made of the case where the frame rate is changed and the communication protocols are switched depending on the number of retransmission requests in the second embodiment, the changing and the switching are not necessarily performed depending on the number of retransmission requests. The switching may be performed depending on the amount of packets of the video content stored in the buffer 411 in the source device, for example. Ina second modification of the second embodiment, if the determination module 852 in the user terminal 800-1 serving as the source device determines that packets of equal to or more than a predetermined capacity are stored in the buffer 411, the transmission path is considered to be congested, and the adjustment module 851 performs adjustment for reducing the frame rate. By contrast, if the determination module 852 determines that no packet is stored in the buffer 411, the transmission path is considered not to be congested. As a result, the adjustment module 851 performs adjustment for increasing the frame rate or the communication processor 802 switches the communication protocol used for the transmission from the connection communication protocol to the connectionless communication protocol.

In the second modification, if the buffer 411 is filled with the video content, it is assumed that display of the video content in the destination is not satisfactory. Therefore, the communication protocols are switched. Thus, transmission of the video content excellent enough to view in the destination can be realized with a simple configuration.

In the first and the second embodiments, the explanation has been made of the case where information related to the transmitted video content is acquired using the retransmission function after the communication protocol is switched to the TCP. Alternatively, by implementing a real-time transport protocol (RTP) and the RTCP in the connectionless communication protocol UDP as an existing technology, it is possible to transmit information related to the transmitted video content to the user terminal serving as the source device.

In this case, the RTCP needs to be implemented to control the session, and a report transmitted to the source device is significantly delayed in the RTCP. Therefore, transmission using the connection communication protocol TCP is performed more simply.

In the conventional technology, if a band wide enough to transmit a video content cannot be ensured because of a bottleneck occurring in a transmission path, a large amount of block-noise is generated in the video in a destination of the video content. As a result, the video content is too deteriorated to view.

By contrast, in the first and the second embodiments and the modifications thereof, the video content is prevented from being too deteriorated to view. While the frame rate of the video content is reduced, it is possible to provide a clear video.

Conventionally, it has been difficult to adjust the frame rate in accordance with the communication rate of the transmission path that changes temporally gradually depending on the congestion state. By contrast, the user terminal according to the first and the second embodiments can adjust the frame rate from the source terminal. As a result, even if the band of the transmission path is too narrow to transmit the video content, it is possible to provide the video content in which block-noise is prevented from being generated by adjusting the frame rate and switching the communication protocols. Therefore, display of the video content in the destination can be compensated.

Instead of the connectionless communication protocol (e.g., the UDP) conventionally used to transmit a video content and an audio content, the connection communication protocol is used to transmit the video content in the first and the second embodiments. As a result, while delay of the video content has to be accepted, it is possible to transmit the video content without any lack.

Conventionally, even if an error occurs while a video content is being transmitted, the video content is not retransmitted. By contrast, in the first and the second embodiments, by repeating a retransmission request for a lacked part of the video content, the video content can be displayed without any lack in the destination. Furthermore, by performing frame skipping from the terminal serving as the source device, the sink device can switch images in an appropriate rate.

Furthermore, when the connection communication protocol is used, reducing the frame rate can reduce the load on the transmission path. As a result, if the transmission path is narrow, it is possible to receive a clear video whose frame rate is low but in which no block-noise is generated.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A video transmitting apparatus comprising:
a first transmitter configured to transmit audio information and video information using a connectionless communication protocol to a communication apparatus connected via a transmission path;
a receiver configured to receive a predetermined request;
an adjustment module configured to, when the receiver receives the predetermined request, perform adjustment for reducing a frame rate of the video information; and
a second transmitter configured to switch from the connectionless communication protocol to a connection communication protocol to transmit the video information adjusted by the adjustment module to the communication apparatus and to maintain transmission of the audio information using the connectionless communication protocol.

2. The video transmitting apparatus of claim 1, wherein the second transmitter is configured to, when number of requests for retransmission of the video information is equal to or smaller than a predetermined number after switching to the connection communication protocol, switch from the connection communication protocol to the connectionless communication protocol to transmit the video information.

3. The video transmitting apparatus of claim 1, wherein the request is configured to be a request indicating that display of the video information is not satisfactory.

4. The video transmitting apparatus of claim 1, wherein the request received by the receiver is a GET request from the communication apparatus.

5. The video transmitting apparatus of claim 1, further comprising:
a rate measuring module configured to measure a data transmission rate in the transmission path between the video transmitting apparatus and the communication apparatus, wherein
the receiver is configured to receive the data transmission rate measured by the rate measuring module as the predetermined request.

6. The video transmitting apparatus of claim 1, further comprising:
a buffer configured to temporarily store therein the video information transmitted by the first transmitter, wherein
the receiver is configured to receive a stored state of the video information in the buffer as the predetermined request.

7. The video transmitting apparatus of claim 1, wherein the request received by the receiver is a PUSH request from an inside of the video transmitting apparatus.

8. A video transmitting apparatus comprising:
a first transmitter configured to transmit audio information using a connectionless communication protocol and video information using a connection communication protocol to a communication apparatus connected via a transmission path; and
a second transmitter configured to, when number of requests for retransmission of the video information using the connection communication protocol is equal to or smaller than a predetermined number, switch from the connection communication protocol to the connectionless communication protocol to transmit the video information and to maintain transmission of the audio information using the connectionless communication protocol.

9. The video transmitting apparatus of claim 8, further comprising:
an adjustment module configured to, when the number of requests for retransmission of the video information using the connection communication protocol is equal to or smaller than the predetermined number and a frame rate of the video information is smaller than a predetermined value, perform adjustment for increasing the frame rate of the video information, wherein
the second transmitter is configured to, when the number of requests for retransmission of the video information using the connection communication protocol is equal to or smaller than the predetermined number and the frame rate of the video information is at the predetermined value, switch from the connection communication protocol to the connectionless communication protocol to transmit the video information.

10. The video transmitting apparatus of claim 1, wherein the second transmitter is configured to, when switching between the connection communication protocol and the connectionless communication protocol, determine whether retransmission of the video information is required using a communication protocol in a higher-level layer than a layer of the connection communication protocol and the connectionless communication protocol and to retransmit the video information when the retransmission is determined to be required.

11. The video transmitting apparatus of claim 1, wherein the transmission path includes a wireless transmission path.

12. A video transmitting method comprising:
transmitting audio information and video information to a communication apparatus connected via a transmission path using a connectionless communication protocol;
receiving a predetermined request indicating that display of the video information is not satisfactory;
performing, when the predetermined request is received at the receiving, adjustment for reducing a frame rate of the video information; and
switching from the connectionless communication protocol to a connection communication protocol to transmit the adjusted video information to the communication apparatus and to maintain transmission of the audio information using the connectionless communication protocol.
